(19) United States
(12) Patent Application Publication
(10) Pub. No.: US 2005/0161850 A1
(43) Pub. Date: Jul. 28, 2005

(54) Composite elements

(76) Inventors: Thomas Droge, Diepholz (DE); Jurgen Mertes, Altrip (DE); Edmund Stadler, Hollfeld (DE); Georg Knoblauch, Munchen (DE); Stefanie Lunne, Rahden (DE); Jurgen Boos, Nordhorn (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/508,180

(22) PCT Filed: Mar. 19, 2003
(86) PCT No.: PCT/EP03/02844

(30) Foreign Application Priority Data
Mar. 26, 2002 (DE) 102-13-753.6

(51) Int. Cl. B29D 1/00

(52) U.S. Cl. 264/45.1

(57) ABSTRACT

In composite elements which have the following layer structure: (i) from 2 to 20 mm of metal, plastic or wood, (ii) from 10 to 300 mm of plastic and (iii) from 2 to 20 mm of metal, plastic or wood, hollow bodies having an external diameter of less than 5 mm are present in the layer (ii).

The present invention relates to composite elements which have the following layer structure:
(i) from 2 to 20, preferably from 2 to 10, particularly preferably from 5 to 10, mm of metal, plastic or wood, preferably metal,
(ii) from 10 to 300, preferably from 10 to 100, mm of plastic, preferably polyisocyanate polyadducts, and
(iii) from 2 to 20, preferably from 2 to 10, particularly preferably from 5 to 10, mm of metal, plastic or wood, preferably metal,
   hollow bodies having an external diameter of less than 5 mm, preferably less than 500 μm, being present in the layer (ii).

The present invention also relates to processes for the production of such composite elements and ships or structures comprising the novel composite elements. The dimensional data stated for the layers (i), (ii) and (iii) relate to the thickness of the respective layers.

For the construction of ships, for example ships' hulls and hold covers, bridges, roofs or multistory buildings, it is necessary to use structural parts which are capable of withstanding considerable loads produced by external forces. Because of these requirements, such structural parts usually consist of metal plates or metal supports which are strengthened by an appropriate geometry or suitable braces. Because of high safety standards, hulls of tankers therefore usually consist of an inner and an outer hull, each hull being composed of 15 mm thick steel plates which are connected to one another by about 2 m long steel braces. Since these steel plates are subject to considerable forces, both the outer and the inner steel hull are stiffened by welded-on reinforcing elements. Both the considerable amounts of steel required and the time-consuming and labor-intensive production are disadvantages of these traditional structural parts. Moreover, such structural parts have a considerable weight, resulting in a lower tonnage of the ships and increased fuel consumption. In addition, such traditional structural elements based on steel require a very great deal of maintenance since both the outer surface and the surfaces of the steel parts between the outer and inner hull have to be regularly protected from corrosion.

SPS (sandwich plate system) elements which comprise a composite of metal and plastic are known as a substitute for the steel structures. Adhesion of the plastic to the two metal layers gives composite elements having extraordinary advantages compared with known steel structures. Such SPS elements are disclosed in U.S. Pat. No. 6,050,208, U.S. Pat. No. 5,778,813, DE-A 198 25 083, DE-A 198 25 085, DE-A 198 25 084, DE-A 198 25 087 and DE-A 198 35 727.

It is an object of the present invention to provide corresponding composite elements having improved thermal stability at low and/or high temperatures.

We have found that this object is achieved, according to the invention, by the composite elements described at the outset.

Compared with the known composite elements, in the production of which, for example, the use of compact glass microspheres was known, the novel composite elements have the following advantages:
lower weight,
introduction of a foam structure into the layer (ii) without it being necessary to load the components with air or to add a blowing agent,
superior mechanical properties of the layer (ii), for example lower storage modulus values at low temperatures and higher storage modulus values at high temperatures.

The hollow bodies preferably have a density of less than 1, particularly preferably from 0.1 to 0.6, g/cm³. The true particle density, i.e. the quotient of the weight of the hollow bodies and the volume of the hollow bodies when the hollow bodies are completely surrounded by gas, is applicable as the density here. The hollow bodies, preferably hollow spheres, preferably have an average wall thickness of from 5 to 20% of the diameter of the hollow body. The hollow bodies may be based on generally known materials, for example plastics, e.g. polyethylene, polypropylene, polyurethane, polystyrene or a blend thereof, or mineral materials, e.g. clay, aluminum silicate or glass, but preferably on glass, aluminum silicate or ceramic, particularly preferably glass. Such hollow bodies are generally known and commercially available. The hollow bodies preferably occupy from 1 to 60%, particularly preferably from 10 to 40%, of the total volume, i.e. including the hollow bodies, of the layer (ii). The hollow bodies may have walls or other structural elements in their cavity. The cavity of the hollow bodies can be filled, for example, with air, inert gases, for example nitrogen, helium or argon, reactive gases, for example oxygen or other known gases, preferably with air, and may be completely or predominantly, preferably completely, enclosed by the material of the hollow bodies which is described at the outset. The hollow bodies may be spherical or irregular in shape. The hollow bodies may have a vacuum or partial vacuum in the cavity. Preferably used hollow bodies are hollow glass microspheres. In a particularly preferred embodiment, the hollow glass microspheres have a compressive strength of at least 15 bar. For example, 3M—Scotchlite® Glass Bubbles or Q-Cel® from Osthoff-Petrasch or Fillite from Trelleborg Fillite can be used as hollow glass microspheres.

The layer (ii) preferably comprises polyisocyanate polyadducts obtainable by reacting the starting materials (a) isocyanate and (b) compounds reactive toward isocyanates. The novel composite elements can therefore preferably be produced by a procedure in which, for the production of (ii), (a) isocyanates and (b) compounds reactive toward isocyanates are reacted in the presence of hollow bodies having an external diameter of less than 500 μm. The hollow bodies can be added to the component (b) and/or the component (a) and/or liquid reaction products of (a) and (b). The addition can be effected directly in the mixing head, for example the pump, or in the storage container of the starting components (a) and/or (b). Mixing of the hollow bodies can be carried out either manually, for example by means of a hand stirrer, or by means of known stirrers. High-pressure and low-pressure machines may be used, it being preferable to modify the mixing head in such a way that the hollow bodies do not break at the shear forces occurring during processing. In the case of very high contents of hollow bodies and/or large composite elements, a component can be simultaneously filled via 2 or more mixing heads or apparatuses.

A suitable mixing apparatus for mixing the novel hollow bodies with (a) and/or (b) and/or reaction products of (a) and (b) is, for example, a preferably continuously operating apparatus comprising
a mixing pot,
a feed line for (a), (b) and/or a liquid reaction product of (a) with (b),
a feed line for hollow microspheres,
a stirring element and
a outlet orifice which can be regulated. This preferred mixing apparatus can be installed upstream or downstream, preferably upstream of the high-pressure and/or low-pressure machine having the mixing head or heads or may be part of these machines.

Conventional reaction vessels, for example made from steel, glass or plastic, e.g. epoxy resin, may serve as the mixing pot. The mixing pot is preferably in the form of a funnel, the outlet orifice being located at the funnel neck. This funnel is preferably arranged vertically. The size of the mixing pot depends on the scale on which the novel process is to be carried out; in general, the mixing pot may be operated from the microscale, for example comprising a volume of a few cm³, to the macroscale, i.e. comprising a volume of up to a few m³. The feeds lead to the mixing pot. In a preferred embodiment, the amounts of feed can be regulated separately from one another. The feed of reactive raw materials for the production of (ii) can be metered, for example, by a known PU metering machine, and the feed of hollow microspheres can be metered, for example, by a screw-type metering apparatus.

The mixing apparatus is preferably equipped with a stirring element. This stirring element ensures mixing on the one hand and, on the other hand, constant transport of the mixture within the mixing pot from the feeds to the outlet orifice. In general, conventional stirrers, for example disk agitators or blade stirrers, are suitable for this purpose. It is preferable if the stirring element is adjusted so that the stirring takes place without dead space. Different stirrer sizes and stirrer geometries permit optimum adaptation to the mixing requirements for different viscosities and throughputs. Furthermore, it is preferable if the stirring element is adjusted, and operated at a speed, such that as far as possible no damage to the hollow microspheres occurs. Usually, a stirring speed of from 100 to 5 000, preferably from 500 to 1 500, particularly preferably from 700 to 1 000, rpm is employed. If, for example, hollow glass microspheres are used, the proportion of damaged hollow glass microspheres after incorporation is in general less than 40, preferably less than 10, more preferably less than 5, particularly preferably less than 2, in particular less than 1, % by weight, based on the total weight of the hollow glass microspheres used. The proportion may vary depending on the density of the hollow spheres used. The starting material containing the novel hollow body for the production of (ii) emerges at the outlet orifice. The outlet orifice can preferably be regulated. In a particularly preferred embodiment, the regulation is effected by means of a conical closure which can be moved in the vertical direction with respect to the outlet orifice. By completely lowering the cone, the outlet orifice can be completely closed; by raising it considerably, said orifice can be completely opened. In this way, metering of the emerging product is possible. In a preferred embodiment, this conical closure is integrated in the stirring element. Other regulating apparatuses which have the desired control effect are, however, also possible. By appropriate metering of the feeds and of the product discharge, the average residence time in the mixing apparatus can be regulated. In general, it is from 0.1 to 10 minutes, preferably from 0.1 to 1 minute. It is furthermore advantageous to control the reaction and the mixing in such a way that the mixture emerging directly at the outlet orifice has a viscosity of from 1 000 to 30 000 mPa·s, the viscosity being determined at room temperature (25° C.) using a rotational viscometer based on the plate-and-cone geometry. Continuous determination of the outflow temperature may also serve as a parameter for an optimum residence time in the mixing pot. An outflow temperature from 20 to 100° C., preferably from 20 to 80° C., particularly preferably from 20 to 50° C., ensures a sufficient open time (until the material has become solid) and prevents an excessively strong exothermic reaction, which would result in the polyurethane solidifying in the mixing pot and would thus cause the termination of the production process. The process can be controled in this manner without considerable technical complexity for a person skilled in the art.

Otherwise, the following may be stated, by way of example, for the production of the composite elements, regardless of the hollow bodies:

The starting materials for the production of (ii) are preferably introduced in the liquid state into the space between (i) and (iii), reduced pressure preferably being generated during this filling process in the space to be filled between (i) and (iii). This has the advantage that the liquid will be sucked into the space and even small cavities will be filled with the liquid. The reduced pressure in the space to be filled is preferably from 0.2 to 0.8 bar, i.e. the pressure in the form to be filled is from 0.8 to 0.2 bar lower than the ambient air pressure. The reduced pressure, which can be generated, for example, by generally known vacuum pumps, is preferably achieved through the fact that (i) and/or (iii) have at least one further orifice (v) via which the reduced pressure is applied, in addition to the orifice or orifices (iv) in (i) and/or (iii) via which the starting materials for the production of (ii) are introduced. A tube is preferably connected between a vacuum pump which generates the reduced pressure and the orifice (v) in (i). This tube may be, for example, pressed or adhesively bonded onto (i). The amounts of starting materials for the production of (ii) are difficult to determine so that the space (S) to be filled is just filled but overflow is prevented. A larger amount of starting components for the production of (ii) than the space between (i) and (iii) can hold is therefore preferably introduced into said space. The resulting overflow is preferably removed via orifices (v). As soon as the space between (i) and (iii) is completely filled with the starting components for the production of (ii), the filling can be terminated by means of a rise of the liquid in the tube, which is preferably transparent, and the orifices (iv) and (v) can be closed. The closing of the orifices can be effected, for example, by means of a plastic or metal plug, preferably having a screw closure, which is present either in the overflow vessel or preferably between overflow vessel and (i) and/or (iii). The orifices (iv) preferably remain closed by the fixed mixing head up to the end of the curing process of the mixture of (a) and (b). The space to be filled between (i) and (iii) preferably has only the orifices (iv) and (v), the outflow end, preferably the mixing head, being present at (iv) and the reduced pressure being applied at (v). Since, in this preferred embodiment, no air can enter the space to be filled, it is possible to generate a reduced pressure.

Usually, the layers (i) and (iii) have no features which can serve for fastening an outflow end for filling the space between (i) and (iii) with liquids. The term outflow end may apply to conventional apparatuses with the aid of which liquids are filled, for example tank nozzles, tube ends, mixing heads, static mixers or the like. The outflow end is preferably a mixing head. Such mixing heads are generally known and are commercially available, for example, in association with conventional metering apparatuses for polyurethane systems. The outflow end, preferably the mixing head, can preferably be fastened by screwing the outflow end of the conveying apparatus or a holder for the outflow end of the conveying apparatus at at least three points, preferably from three to six points, particularly preferably four or five points, to the layer (i). The liquid is preferably introduced through at least one orifice (iv) in (i) and/or (iii) into the space between (i) and (iii). For fastening, for example, a mixing head, bolts which have a thread and serve for fastening the mixing head or a holder for the mixing head can be driven into the layer (i). These bolts can preferably taper to a point on the side facing away from the thread, in order to be able to introduce them more easily into the layer (i). The bolts preferably have a diameter of from 6 to 20 mm and a length of from 8 to 42 mm. The thread, which is directed outward after fixing of the bolts, i.e. on that side of (i) which faces away from (iii), preferably has a length of from 4 to 30 mm. The bolts are introduced, for example, by driving by means of a bolt driver commercially available from, for example, Hilti. Therefore, (i) preferably has threads with the aid of which the outflow end is screwed to (i), at the orifice (iv) through which the liquid is introduced. In order to improve the seal between the outflow end and the layer (i), an O-ring comprising a resilient material can be fixed between the layer (i) and the mixing head. Such O-rings are generally known and can be tailored in their dimensions to the diameter of the orifice (iv) and the mixing head. The mixing head is therefore preferably fixed tightly to the orifice (iv) in (i) or (iii) through which the starting materials are introduced.

Particularly preferably, the outflow end is not fastened directly to the layer (i) but is fixed to a holder which is screwed to (i). This holder, which may consist of conventional materials, for example plastics, wood or preferably conventional metals, is preferably a construction which has bores through which the threads fixed on (i) are passed and fastened, for example by means of corresponding nuts. In addition, the holder has fastening elements for the outflow end, for example plug connectors, screw connectors or edges by means of which the outflow end can be clamped on the holder by means of elastic bands. Particularly preferably, the outflow end is fastened to the holder at at least three points, in order to avoid tilting. Thus, a holder is screwed on at least three threads which are fastened to (i), and the mixing head is fixed on this holder. After completion of the composite elements, the bolts can, for example, be sawn off at the surface of (i).

The filling of the space between (i) and (iii) can be carried out, preferably continuously, using conventional conveying apparatuses, for example using high-pressure and low-pressure machines, preferably low-pressure machines. The filling is preferably effected using a low-pressure machine (e.g. from Cannon) via one or more mixing heads, preferably one mixing head, in which the starting components are mixed, in a single operation, preferably injection process. In a single injection process means that the filling of the space between (i) and (iii), for example with the starting materials for the production of (ii), is not interrupted before filling is complete. The starting materials are thus preferably introduced in a single shot under pressure into the space between (i) and (iii). This is true in particular when the liquid is a reactive mixture which cures with the reaction. The starting materials are therefore preferably introduced by means of a high-pressure apparatus via one or more mixing heads, preferably one mixing head. The filling of the space between (i) and (iii) can be effected either with vertical orientation of (i) and (iii) or horizontal orientation of (i) and (iii).

The layers (i) and (iii) can preferably be used as conventional plastic, wood or preferably metal plates, for example iron, steel, copper and/or aluminum plates, having the novel thicknesses.

Both (i) and (ii) can be coated, for example primed or finished and/or coated with conventional plastics, before being used for the production of the novel composite elements. Preferably, (i) and (iii) are used in an uncoated form and particularly preferably after cleaning, for example by conventional sand blasting.

The space to be filled can preferably be dried. This has the advantage that particularly liquid components to be filled which are reactive toward water, for example isocyanates, do not undergo undesirable secondary reaction. The drying, which preferably takes place directly before the filling, can be carried out, for example, by means of hot air or by means of compressed air. Furthermore, the space to be filled between (i) and (iii) can be dried by heating (i) and/or (iii) to a temperature of from 20 to 150° C. for from 10 to 180 minutes. The space to be filled between (i) and (iii) can preferably be dried by means of a blower which passes air through orifices (iv) and (v) in (i) and/or (iii) and through the space to be filled between (i) and (iii).

The orifices (iv) and (v) are preferably bores in (i) and/or (iii) having a diameter of from 0.5 to 5.0 cm in (i) and/or (iii).

The space which is filled between (i) and (iii) with the starting materials for the production of (ii) need not represent the total space between (i) and (iii). Both (i) and (iii) can project beyond (ii) at the edges, i.e. (i) is bonded to (iii) by (ii) only in a part of (i) and (iii). For example, the space between (i) and (iii) can be sealed, prior to filling with the starting materials, in such a way that the seal is present inside the space enclosed by (i) and (iii) and edges of (i) and/or (iii) project.

The delivery can be varied depending on the volume to be filled. In order to ensure homogeneous thorough curing of (ii), the delivery and conveying apparatus are preferably chosen so that the space to be filled can be filled within from 0.5 to 20 minutes with the components for the production of (ii). Preferably high-pressure or particularly preferably low-pressure machines, preferably having eccentric screw pumps, are employed, the storage container preferably being equipped with a stirrer and preferably being thermostatable and a storage container-mixing head-storage container circulation preferably being present, the discharge preferably being from 0.1 to 3.0 kg/sec.

In the development of suitable production processes, it was found that uncontroled running out of liquid starting components for the production of (ii) is an error which can scarcely be eliminated. Owing to the limited amount per shot, an uncontroled loss of starting material for the production of (ii) leads to incomplete filling of the space between (i) and (iii). Because of the rapid reaction and the very good adhesion of (ii) to (i) and (iii), incomplete filling results in extensive regions in the composite element which contain no (ii) and also can no longer be filled with starting components. Such composite elements unfortunately have to be discarded.

In order to prevent a loss of starting components, it has therefore proven advantageous very carefully to check the mold to be filled with regard to its tightness. Usually, the layers (i) and (iii) are fixed in a suitable arrangement, for example parallel to one another. The distance is usually chosen so that the space (S) between (i) and (iii) has a thickness of from 10 to 300 mm. The fixing of (i) and (iii) can be effected, for example, by spacers, for example in a mold or suitable holder. The edges of the intermediate space are usually sealed in such a way that the space between (i) and (iii) can be completely filled with the liquid or the starting components for the production of (ii) but running out of these components before complete filling is prevented. The sealing can be effected using conventional plastic films and/or sheets, paper sheets or metal foils and/or plates, which are adhesively bonded, welded or pressed on and which, if required, may also serve as spacers. This preferred sealing does not relate to the preferred orifices (iv) and (v) which were described at the outset.

Checking of the tightness of (S) prior to filling with the starting components is preferably carried out by pressure difference measurement. The term pressure difference measurement is to be understood as meaning that an attempt is made to establish a pressure difference between the space (S) and the outer environment over a specific period, for example by attempting to achieve a reduced pressure or excess pressure in (S) in relation to the outer environment. This can be achieved by means of conventional vacuum pumps or generally known compressors which pump air or gas into the space (S). If a stable reduced pressure or excess pressure can be generated in (S), this indicates a sufficiently tight cavity which can be filled with the starting components for the production of (ii). It should preferably be ensured that the orifices (iv) and (v) which are provided for filling (S) with the starting components or as vent orifices or as overflow orifices for the emergence of excess starting components are likewise temporarily sealed. If required, at least one of these orifices may serve for connecting the vacuum pump or compressor to (S).

The mold to be filled preferably consists of said layers (i) and (iii), and (vi), which are preferably arranged parallel, and preferably of seals between the layers (i) and (iii), which prevent running out of the liquid during filling. The layer (ii) is thus preferably arranged with adhesion between the layers (i) and (iii).

The novel composite elements can preferably be produced by fixing a sheet-like structure (vi) substantially parallel, preferably parallel, to the layer (i) and preferably at a distance of from 5 to 150 mm, preferably from 15 to 50 mm, particularly preferably from 15 to 30 mm, fixing the layer (iii) substantially parallel to (i) and (vi), sealing the space to be filled with (ii), with the exception of orifices, for example the orifices (iv) and (v) described in this document and required for filling, and then filling the space to be filled with the starting materials for the production of (ii). The fixing of (vi) to (i) can be effected with a horizontal orientation of (i), for example by placing spacers, for example wood, plastic or metal blocks having a suitable height, on the layer (i) and placing the structure (vi) on these spacers. The layer (iii) can then be fixed a suitable distance away, i.e. with a suitable layer thickness of (ii), preferably parallel to (i) and (vi), for example by fixing, for example welding, metal plates to (i) at the edges of the space which (ii) is to occupy, preferably perpendicular to (i), and fixing, for example welding, the layer (iii) to these metal plates which define and seal the lateral edge of (ii). The starting materials are preferably introduced continuously without interruption, in a single operation, into the space to be filled between (i) and (iii); particularly preferably, the starting materials are introduced, for example filled, by means of a high-pressure apparatus via one or more mixing heads.

The liquid for the production of (ii) preferably contains (a) isocyanates and (b) compounds reactive toward isocyanates. The layer (ii) thus preferably comprises polyisocyanate polyadducts. In this document, the terms starting materials or starting components are to be understood as meaning in particular (a) isocyanates and (b) compounds reactive toward isocyanates, but possibly, where used, also (c) gases, (d) catalysts, (e) assistants and/or (f) blowing agents.

The starting components for the preparation of the polyisocyanate polyadducts are usually mixed at from 0 to 100° C., preferably from 20 to 60° C., and introduced into the space between (i) and (iii) as described above. The mixing can be effected mechanically by means of a stirrer or a spiral stirrer. The reaction temperature, i.e. the temperature at which reaction takes place, is usually >20° C., preferably from 50 to 150° C., depending on the material thickness.

The layer (ii) of the composite elements produced according to the invention preferably has a modulus of elasticity of >275 MPa in the temperature range from −45 to +50° C. (according to DIN 53457), an adhesion to (i) and (iii) of >4 MPa (according to DIN 53530), an elongation of >30% in the temperature range from −45 to +50° C. (according to DIN 53504), a tensile strength of >20 MPa (according to DIN 53504) and a compressive strength of >20 MPa (according to DIN 53421). The density of the layer (ii), i.e. including the novel hollow bodies, is preferably from 350 to 1 200, particularly preferably from 650 to 1 000, kg/m³.

The novel-composite elements can be produced by a procedure in which polyisocyanate polyadducts (ii), usually polyurethanes, which may have urea and/or isocyanurate structures, are prepared between (i) and (iii) by reacting (a) isocyanates with (b) compounds reactive toward isocyanates, in the presence or absence of blowing agents (f), from 1 to 50% by volume, based on the volume of the polyisocyanate polyadducts, of at least one gas (c), (d) catalysts and/or (e) assistants, (ii) preferably adhering to (i) and (iii). The preparation of such polyisocyanate polyadducts (ii) has been widely described.

The surfaces of (i) and (iii) can be blasted with sand or steel shot, preferably with corundum or iron pyrites, before the production of the composite elements, for cleaning and increasing the surface roughness. This blasting can be effected by the conventional methods in which the blasting material strikes the surfaces, for example under high pressure. Suitable apparatuses for such a treatment are commercially available.

This treatment of the surfaces of (i) and (iii), which are in contact with (ii) after the reaction of (a) with (b), leads to a substantially improved adhesion of (ii) with (i) and (iii). The blasting is preferably carried out directly before the introduction of the components for the production of (ii) into the space between (i) and (iii). The surfaces of (i) and (iii) to which (ii) is to adhere are preferably free of inorganic and/or organic substances which reduce adhesion, for example dust, dirt, oils and fats or substances generally known as mold release agents.

The starting materials (a), (b), (c), (d), (e) and (f) in the novel process are described below by way of example:

Suitable isocyanates (a) are the aliphatic, cycloaliphatic or araliphatic and/or aromatic isocyanates known per se, preferably diisocyanates, which may have been biuretized and/or isocyanurated by generally known methods. Specific examples are alkylene diisocyanates having 4 to 12 carbon atoms in the alkylene radical, such as dodecane 1,12-diisocyanate, 2-ethyltetramethylene 1,4-diisocyanate, 2-methylpentamethylene 1,5-diisocyanate, tetramethylene 1,4-diisocyanate, lysine ester diisocyanates (LDI), hexamethylene 1,6-diisocyanate (HDI), cyclohexane 1,3- and/or 1,4-diisocyanate, hexahydrotolylene 2,4- and 2,6-diisocyanate and the corresponding isomer mixtures, dicyclohexylmethane 4,4′-, 2,2′- and 2,4′-diisocyanates and the corresponding isomer mixtures, 1-isocyanato-3,3,5-trimethyl-5-isocyanatomethylcyclohexane (IPDI), tolylene 2,4- and/or 2,6-diisocyanate (TDI), diphenylmethane 4,4′-, 2,4′- and/or 2,2′-diisocyanate (MDI), polyphenylpolymethylene polyisocyanates and/or mixtures containing at least two of said isocyanates. Di- and/or polyisocyanates containing ester, urea, allophanate, carbodiimide, uretdione and/or urethane groups can also be used in the novel process. 2,4′-, 2,2′- and/or 4,4′-MDI and/or polyphenylpolymethylene polyisocyanates are preferably used, particularly preferably mixtures containing polyphenylpolymethylene polyisocyanates and at least one of the MDI isomers.

For example, compounds which have hydroxyl, thiol and/or primary and/or secondary amino groups as groups reactive toward isocyanates and usually have a molecular weight of from 60 to 10 000 g/mol, e.g. polyols selected from the group consisting of the polymer polyols, polyetherpolyalcohols, polyesterpolyalcohols, polythioetherpolyols, hydroxyl-containing polyacetals and hydroxyl-containing aliphatic polycarbonates or mixtures of at least two of said polyols, can be used as (b) compounds reactive toward isocyanates. These compounds usually have a functionality of from 2 to 6 with respect to isocyanates and a molecular weight of from 400 to 8 000 and are generally known to a person skilled in the art.

Examples of suitable polyetherpolyalcohols are those which are obtainable by known technology by means of an addition reaction of alkylene oxides, for example tetrahydrofuran, 1,3-propylene oxide, 1,2- or 2,3-butylene oxide, styrene oxide and preferably ethylene oxide and/or 1,2-propylene oxide, with conventional initiator substances. Initiator substances which may be used are, for example, known aliphatic, araliphatic, cycloaliphatic and/or aromatic compounds which contain at least one hydroxyl group, preferably from 2 to 4 hydroxyl groups, and/or at least one amino group, preferably from 2 to 4 amino groups. For example, ethanediol, diethylene glycol, 1,2- or 1,3-propanediol, 1,4-butanediol, 1,5-pentanediol, 1,6-hexanediol, 1,7-heptanediol, glycerol, trimethylolpropane, neopentylglycol, sugars, for example sucrose, pentaerythritol, sorbitol, ethylenediamine, propanediamine, neopentanediamine, hexamethylenediamine, isophoronediamine, 4,4′-diaminodicyclohexylmethane, 2-(ethylamino)ethylamine, 3-(methylamino)propylamine, diethylenetriamine, dipropylenetriamine and/or N,N′-bis(3-aminopropyl)ethylenediamine can be used as initiator substances.

The alkylene oxides can be used individually, alternately in succession or as mixtures. Preferably used alkylene oxides are those which lead to primary hydroxyl groups in the polyol. Particularly preferably used polyols are those which were alkoxylated with ethylene oxide at the end of the alkoxylation and thus have primary hydroxyl groups.

In general, compounds known from polyurethane chemistry, preferably styrene/acrylonitrile graft polyols, can be used as polymer polyols, a special class of the polyetherpolyols.

It is precisely the use of polymer polyols that can substantially reduce the shrinkage of the polyisocyanate polyadducts, for example of the polyurethane, and hence lead to improved adhesion of (ii) to (i) and (iii). Blowing agents (f) and/or gases (c) can preferably be used, if required, as further measures for reducing the shrinkage.

Suitable polyesterpolyols can be prepared, for example, from organic dicarboxylic acids of 2 to 12 carbon atoms, preferably aliphatic dicarboxylic acids of 4 to 6 carbon atoms, and polyhydric alcohols, preferably diols, of 2 to 12, preferably 2 to 6, carbon atoms. The polyesterpolyols preferably have a functionality of from 2 to 4, in particular from 2 to 3, and a molecular weight of from 480 to 3 000, preferably from 600 to 2 000, in particular from 600 to 1500.

The novel composite elements are preferably produced using polyetherpolyalcohols as component (b) for reaction with the isocyanates, expediently those having an average functionality with respect to isocyanates of from 1.5 to 8, preferably from 2 to 6, and a molecular weight of from 400 to 8 000.

The use of polyetherpolyalcohols has considerable advantages through improved stability of the polyisocyanate polyadducts to hydrolytic cleavage and because of the lower viscosity, in each case in comparison with polyesterpolyalcohols. The improved stability to hydrolysis is advantageous in particular for use in shipbuilding. The lower viscosity of the polyetherpolyalcohols and of the reaction mixture for the production of (ii) containing the polyetherpolyalcohols permits faster and easier filling of the space between (i) and (iii) with the reaction mixture for the production of the composite elements. Owing to the considerable dimensions, in particular of structural parts in shipbuilding, low-viscosity liquids are of considerable advantage.

As compounds reactive toward isocyanates, if required diols and/or triols having molecular weights of from 60 to <400 may furthermore be used as chain extenders and/or crosslinking agents in the novel process, in addition to said compounds having a customary molecular weight of from 400 to 8 000. However, the addition of chain extenders, crosslinking agents or, if required, mixtures thereof may prove advantageous for modifying the mechanical properties, for example the hardness. The chain extenders and/or crosslinking agents preferably have a molecular weight of from 60 to 300. For example, aliphatic, cycloaliphatic and/or araliphatic diols of 2 to 14, preferably 4 to 10, carbon atoms, e.g. ethylene glycol, 1,3-propanediol, 1,10-decanediol, o-, m- and p-dihydroxycyclohexane, diethylene glycol, dipropylene glycol and preferably 1,4-butanediol, 1,6-hexanediol and bis(2-hydroxyethyl)hydroquinone, triols, such as 1,2,4- and 1,3,5-trihydroxycyclohexane, glycerol and trimethylolpropane, low molecular weight hydroxyl-containing polyalkylene oxides based on ethylene oxide and/or 1,2-propylene oxide and the abovementioned diols and/or triols, as initiator molecules and/or diamines, such as diethylenetoluenediamine and/or 3,5-dimethylthio-2,4-toluenediamine, are suitable.

If chain extenders, crosslinking agents or mixtures thereof are used for the preparation of the polyisocyanate polyadducts, they are expediently employed in an amount of from 0 to 30, preferably from 1 to 30, % by weight, based on the total weight used of compounds (b) reactive toward isocyanates.

Aliphatic, araliphatic, cycloaliphatic and/or aromatic carboxylic acids for optimizing the course of the curing during the production of (ii) can also be used as (b). Examples of such carboxylic acids are formic acid, acetic acid, succinic acid, oxalic acid, malonic acid, glutaric acid, adipic acid, citric acid, benzoic acid, salicylic acid, phenylacetic acid, phthalic acid, toluenesulfonic acid, derivatives of said acids, isomers of said acids and any desired mixtures of said acids. The amount by weight of these acids may be from 0 to 5, preferably from 0.2 to 2, % by weight, based on the total weight of (b).

With the use of amine-initiated polyetherpolyalcohols, it is also possible to improve the curing behavior of the reaction mixture for the production of (ii). The compounds (b) as well as the other components for the production of (ii) are preferably used with a very low content of water, in order to avoid the formation of carbon dioxide by reaction of the water with isocyanate groups.

Generally known compounds which have a boiling point at 1 bar of less than (i.e. at temperatures lower than) −50° C., for example air, carbon dioxide, nitrogen, helium and/or neon, can be used as component (c) for the production of (ii). Air is preferably used. The component (c) is preferably inert to the component (a), particularly preferably to the components (a) and (b), i.e. a reactivity of the gas with respect to (a) and (b) is scarcely detectable, preferably undetectable. Use of the gas (c) differs fundamentally from the use of conventional blowing agents for the preparation of foamed polyurethanes. While conventional blowing agents (f) are used in liquid form (or in the case of the gaseous physical blowing agents are soluble in the polyol component to a low percentage) and during the reaction either vaporize owing to the evolution of heat or, in the case of water, evolve gaseous carbon dioxide owing to the reaction with the isocyanate groups, the component (c) is preferably already used in gaseous form as an aerosol, for example in the polyol component, in the present invention.

Generally known compounds which greatly accelerate the reaction of isocyanates with the compounds reactive toward isocyanates can be used as catalysts (d), a total catalyst content of from 0.001 to 15, in particular from 0.05 to 6, % by weight, based on the total weight used of compounds reactive toward isocyanates preferably being employed. For example, the following compounds may be used: triethylamine, tributylamine, dimethylbenzylamine, dicyclohexylmethylamine, dimethylcyclohexylamine, N,N,N′,N′-tetramethyldiaminodiethyl ether, bis(dimethylaminopropyl)urea, N-methyl- and N-ethylmorpholine, N-cyclohexylmorpholine, N,N,N′,N′-tetramethylethylenediamine, N,N,N′,N′-tetramethylbutanediamine, N,N,N′,N′-tetramethylhexane-1,6-diamine, pentamethyldiethylenetriamine, dimethylpiperazine, N-dimethylaminoethylpiperidine, 1,2-dimethylimidazole, 1-azabicyclo[2.2.0]octane, 1,4-diazabicyclo[2.2.2]octane (Dabco) and alkanolamine compounds, such as triethanolamine, triisopropanolamine, N-methyl- and N-ethyldiethanolamine, dimethylaminoethanol, 2-(N,N-dimethylaminoethoxy)ethanol, N,N′,N″-tris(dialkylaminoalkyl)hexahydrotriazines, e.g. N,N′,N″-tris(dimethylaminopropyl)-s-hexahydrotriazine, iron(II) chloride, zinc chloride, lead octanoate and preferably tin salts, such as tin dioctanoate, tin diethylhexanoate, dibutyltin dilaurate and/or dibutyldilauryltin mercaptide, 2,3-dimethyl-3,4,5,6-tetrahydropyrimidine, tetraalkylammonium hydroxides, such as tetramethylammonium hydroxide, alkali metal hydroxides, such as sodium hydroxide, alkali metal alcoholates, such as sodium methylate or potassium isopropylate, and/or alkali metal salts of long-chain fatty acids having 10 to 20 carbon atoms and, if required, OH side groups.

It has proven very advantageous to carry out the production of (ii) in the presence of (d) in order to accelerate the reaction.

If required, (e) assistants may be incorporated into the reaction mixture for the preparation of the polyisocyanate polyadducts (ii). Examples are fillers, surface-active substances, dyes, pigments, flameproofing agents, hydrolysis stabilizers, fungistatic and bacteriostatic substances and foam stabilizers.

Examples of suitable surface-active substances are compounds which serve for supporting the homogenization of the starting materials and may also be suitable for regulating the structure of the plastics. Examples are emulsifiers, such as the sodium salts of castor oil sulfates or of fatty acids and salts of fatty acids with amines, for example of oleic acid with diethylamine, of stearic acid with diethanolamine and of ricinoleic acid with diethanolamine, salts of sulfonic acids, for example alkali metal or ammonium salts of dodecylbenzene- or dinaphthylmethanedisulfonic acid, and ricinoleic acid. The surface-active substances are usually used in amounts of from 0.01 to 5% by weight, based on 100% by weight of the total amount used of compounds (b) reactive toward isocyanates.

Suitable flameproofing agents are, for example, tricresyl phosphate, tris(2-chloroethyl) phosphate, tris(2-chloropropyl) phosphate, tris(1,3-dichloropropyl) phosphate, tris(2,3-dibromopropyl) phosphate, tetrakis(2-chloroethyl) ethylene diphosphate, dimethyl methanephosphonate, diethyl diethanolaminomethylphosphonate and commercial halogen-containing polyol flameproofing agents. In addition to the abovementioned halogen-substituted phosphates, inorganic or organic flameproofing agents, such as red phosphorus, aluminum oxide hydrate, antimony trioxide, arsenic oxide, ammonium polyphosphate and calcium sulfate, expanded graphite or cyanuric acid derivatives, e.g. melamine, or mixtures of at least two flameproofing agents, e.g. ammonium polyphosphates and melamine and, if required, cornstarch or ammonium polyphosphate, melamine and expanded graphite and/or, if required, aromatic polyesters, can also be used for flameproofing the polyisocyanate polyadducts. In general, it has proven expedient to use from 5 to 50, preferably from 5 to 25, % by weight, based on the total weight used of the compounds reactive toward isocyanates, of said flameproofing agents.

Fillers which may be used in addition to the novel hollow bodies are to be understood as meaning, for example, the conventional organic and inorganic fillers, reinforcing materials, weighting materials, compositions for improving the abrasion behavior in surface coatings, coating materials, etc., which are known per se. Specific examples are inorganic fillers, such as silicate minerals, for example sheet silicates, such as antigorite, serpentine, hornblendes, amphiboles, chrysotile and talc, metal oxides, such as kaolin, aluminas, titanium oxides and iron oxides, metal salts, such as chalk and barite, and inorganic pigments, such as cadmium sulfide and zinc sulfide, and glass, etc. Kaolin (china clay), aluminum silicate and coprecipitates of barium sulfate and aluminum silicate and natural and synthetic fibrous minerals, such as wollastonite, and short metal and glass fibers are preferably used. Examples of suitable organic fillers are carbon, melamine, rosin, cyclopentadienyl resins and graft polymers and cellulosic fibers, polyamide, polyacrylonitrile, polyurethane and polyester fibers based on aromatic and/or aliphatic dicarboxylic esters and in particular carbon fibers.

The inorganic and organic fillers may be used individually or as mixtures.

Preferably from 10 to 70% by weight, based on the weight of (ii), of fillers are used as (e) assistants in the production of (ii). Preferably used fillers are talc, kaolin, calcium carbonate, barite, glass fibers and/or glass microspheres. The size of the filler particles should preferably be chosen so that the introduction of the components for the production of (ii) into the space between (i) and (iii) is not hindered. The fillers particularly preferably have particle sizes of <0.5 mm.

The fillers are preferably used as a mixture with the polyol component in the reaction for the preparation of the polyisocyanate polyadducts.

The fillers may serve for reducing the coefficient of thermal expansion of the polyisocyanate polyadducts, which is greater in comparison with, for example, steel, and thus for adapting it to that of steel. This is particularly advantageous for a permanently strong bond between the layers (i), (ii) and (iii) since lower stresses occur thereby between the layers under thermal load.

Conventional foam stabilizers which are commercially available and are generally known to a person skilled in the art, for example generally known polysiloxane/polyoxyalkylene block copolymers, e.g. Tegostab 2219 from Goldschmidt, are preferably used as (e) for the production of (ii). The proportion of these foam stabilizers during the production of (ii) is preferably from 0.001 to 10, particularly preferably from 0.01 to 10, in particular from 0.01 to 2, % by weight, based on the weight of the components (b), (e) and, if required, (d) used for the production of (ii). The use of these foam stabilizers ensures that the component (c) is stabilized in the reaction mixture for the production of (ii).

Blowing agents generally known from polyurethane chemistry can be used as blowing agents (f), for example physical and/or chemical blowing agents. Such physical blowing agents generally have a boiling point at 1 bar of greater than (i.e. at temperatures higher than) −50° C. Examples of physical blowing agents are CFCs, HCFCs, HFCs, aliphatic hydrocarbons, cycloaliphatic hydrocarbons, in each case of, for example, 4 to 6 carbon atoms, or mixtures of these substances, for example trichlorofluoromethane (boiling point 24° C.), chlorodifluoromethane (boiling point −40.8° C.), dichlorofluoroethane (boiling point 32° C.), chlorodifluoroethane (boiling point −9.2° C.), dichlorotrifluoroethane (boiling point 27.1° C.), tetrafluoroethane (boiling point −26.5° C.), hexafluorobutane (boiling point 24.6° C.), isopentane (boiling point 28° C.), n-pentane (boiling point 36° C.) and cyclopentane (boiling point 49° C.).

Suitable chemical blowing agents, i.e. blowing agents which form gaseous products owing to a reaction, for example with isocyanate groups, are, for example, water, compounds containing water of hydration, carboxylic acids, tert-alcohols, e.g. tert-butanol, carbamates, for example the carbamates described in EP-A 1000955, in particular on page 2, lines 5 to 31, and page 3, lines 21 to 42, carbonates, e.g. ammonium carbonate and/or ammonium bicarbonate, and/or guanidine carbamate.

Water and/or carbamates are preferably used as blowing agents (f).

The blowing agents (f) are preferably used in an amount which is sufficient for obtaining the preferred density (ii) of from 350 to 1 200 kg/m³. This can be determined by simple routine experiments which are in general familiar to a person skilled in the art. The blowing agents (f) are particularly preferably used in an amount of from 0.05 to 10, in particular from 0.1 to 5, % by weight, based in each case on the total weight of the polyisocyanate polyadducts.

The weight of (ii) corresponds by definition to the weight of the components (a), (b) and, if required, (c), (d), (e) and/or (f) used in the production of (ii).

For the preparation of the novel polyisocyanate polyadducts, the isocyanates and the compounds reactive toward isocyanates are reacted in amounts such that the ratio of the number of equivalents of NCO groups of the isocyanates (a) to the sum of the reactive hydrogen atoms of the compounds (b) reactive toward isocyanates and, if required, (f) is from 0.85:1 to 1.25:1, preferably from 0.95:1 to 1.15:1, in particular from 1:1 to 1.05:1. If at least some of the isocyanurate groups are present in bound form in (ii), a ratio of NCO groups to the sum of the reactive hydrogen atoms of from 1.5:1 to 60:1, preferably from 1.5:1 to 8:1, is usually used.

The polyisocyanate polyadducts are usually prepared by the one-shot process or by the prepolymer process, for example with the aid of the high pressure or low pressure technique.

It has proven particularly advantageous to employ the two-component process and to combine the compounds (b) reactive toward isocyanates, if required the blowing agents (f) and, if required, the catalysts (d) and/or assistants (e) in the component (A) (polyol component) and preferably to mix them thoroughly with one another, and to use the isocyanates (a) as component (B).

The component (c) can be added to the reaction mixture containing (a), (b) and, if required, (f), (d) and/or (e) and/or to the individual components (a), (b), (A) and/or (B) described above. The component which is mixed with (c) is usually present in liquid form. The components are preferably mixed into the component (b).

The mixing of the corresponding component with (c) can be carried out by generally known methods. For example, (c) can be fed to the corresponding component by generally known loading means, for example air loading means, preferably under pressure, for example from a pressurized container or compressed by a compressor, for example through a nozzle. Further thorough mixing of the corresponding components with (c) is preferably effected so that gas bubbles of (c) in the usually liquid component preferably have a size of from 0.0001 to 10, particularly preferably from 0.0001 to 1, mm.

The content of (c) in the reaction mixture for the production of (ii) can be determined in the return line of the high pressure machine by means of generally known measuring apparatuses, via the density of the reaction mixture. The content of (c) in the reaction mixture can be regulated by means of a control unit, preferably automatically on the basis of this density. The component density can be determined and regulated online during the usual circulation of the material in the machine, even at very low circulation velocity.

The composite elements obtainable according to the invention are used in particular in areas which require structural elements which withstand large forces, for example as structural parts in shipbuilding, for example in ships' hulls, for example double hulls of ships, comprising an outer and an inner wall, and hold covers, hold bulkheads or loading flaps, or in structures, for example bridges, or as structural elements in house building, in particular in multistory buildings.

The novel composite elements should not be confused with traditional sandwich elements which contain a rigid polyurethane and/or polyisocyanurate foam as the core and are usually used for thermal insulation. Owing to their comparatively low mechanical strength, such known sandwich elements would not be suitable for said applications.

The novel composite elements preferably have a width of from 0.2 to 5 m, preferably from 0.5 to 3 m, and a length of from 0.5 to 10 m, preferably from 1 to 5 m.

1. A process for the production of a composite element which has the following layer structure:
(i) from 2 to 20 mm of metal, plastic or wood,
(ii) from 10 to 300 mm of plastic and
(iii) from 2 to 20 mm of metal, plastic or wood,
wherein hollow bodies having an external diameter of less than 5 mm are present in the layer (ii), wherein, for the production of (ii), (a) isocyanates and (b) compounds reactive toward isocyanates are reacted in the presence of hollow bodies having an external diameter of less than 500 μm, wherein the hollow bodies are added to component (b) and/or component (a) and/or liquid reaction products of (a) and (b).

2. A process as claimed in claim 1, wherein the hollow bodies have a density of less than 1 g/cm³.

3. A process as claimed in claim 1, wherein the hollow bodies have an average wall thickness of from 5 to 20% of the diameter of the hollow body.

4. A process as claimed in claim 1, wherein the hollow bodies are based on glass, aluminum silicate or ceramic.

5. A process as claimed in claim 1, wherein the hollow bodies occupy from 1 to 60% of the total volume of the layer (ii).
